(19) United States
(12) Patent Application Publication
(10) Pub. No.: US 2025/0380791 A1
(43) Pub. Date: Dec. 18, 2025

(54) ATTACHMENT DEVICE COMPRISING AN ATTACHMENT AREA BETWEEN TWO STRANDS, LANYARD COMPRISING ONE SUCH ATTACHMENT DEVICE

(71) Applicant: ZEDEL, Crolles (FR)

(72) Inventors: Jean-Marc HEDÉ, Domène (FR); Matthieu STABILE, La Motte-Saint-Martin (FR)

(73) Assignee: ZEDEL, Crolles (FR)

(21) Appl. No.: 19/233,533

(22) Filed: Jun. 10, 2025

(30) Foreign Application Priority Data
Jun. 18, 2024 (FR) 2406525

(51) Int. Cl. A45F 5/00

(52) U.S. Cl. CPC A45F 5/00; A45F 2005/006

(57) ABSTRACT

An attachment device comprises a first rope strand and a second rope strand fixed to one another by a seam area and a ligature area arranged adjacently in the longitudinal directions of the strands. First stitching points pass successively through the first strand and second strand to fixedly secure the two strands pressing on one another to form the seam area. Second stitching points surround at least one of the first strand and second strand and may pass through the other of the first strand and second strand to fixedly secure the first strand pressing firmly against the second strand and form the ligature area. A lanyard comprises the attachment device.

### BACKGROUND OF THE INVENTION

The invention relates to an attachment device comprising an attachment area between two strands, and to a lanyard comprising such an attachment device.

### PRIOR ART

In the field of mountaineering and rope access work, ropes are commonly used that are configured in the form of lanyards, for example adjustable lanyards.

An exemplary embodiment of an adjustable lanyard is illustrated in FIGS. 1, 2 and 3. The adjustable lanyard 1 has a rope 2 that can be divided into a primary strand 2a and a secondary strand 2b. The primary strand 2a is attached to the secondary strand 2b to form a loop designed to form an attachment ring that has to be attached to a roping harness. The primary strand 2a is attached to the secondary strand 2b by an attachment area 4 that is formed by a seam area 5 comprising several stitching points 6. The stitching points are achieved by means of a sewing machine that joins two sewing threads together to form the stitching points.

Each strand has a first end that is fixed to the user whereas the other end has a connector 7 designed to be attached to an anchor point. The connector 7 can be a carabiner, a ring or a loop of the rope able to receive a carabiner or any other object. The primary strand 2a is a fixed strand whereas the secondary strand 2b is an adjustable strand. In the illustrated embodiment, the primary strand 2a is terminated by a fixed connector whereas the secondary strand 2b is terminated by a movable connector that defines an adjustable strand.

The adjustable strand has a connector 7 fixed to an adjustment device 8. The adjustment device 8 is installed movable between a sliding position and a blocking position. The adjustable strand is terminated by an end-of-travel stop that defines a maximum accessible position for the adjustment device 8.

In the sliding position, the adjustment device 8 is able to slide along the secondary strand 2b in either direction. In the blocking position illustrated in FIGS. 1 to 3, the adjustment device 8 is installed in fixed manner with respect to the secondary strand 2b. The secondary strand 2b is divided into a main strand 2′ and a terminal strand 2″ that is folded and sewn onto the main strand 2′ to form the end-of-travel stop. The stitching of main strand 2′ with terminal strand 2″ forms an attachment area 4.

During its use, when the adjustment device 8 is pressing against the end-of-travel stop, the adjustment device 8 applies a force on the attachment area 4. The force applied on the end-of-travel stop by the adjustment device 8 has the effect of applying a peeling force between the two strands 2a/2b fixed to one another. The stitching points 6 are arranged successively in the longitudinal direction of the strands. The force applied by the adjustment device 8 and the tension in the sewing thread mean that the stitching points 6 work in peeling stress mode one after the other. The resistance procured by the seam area 5 is not as high as expected. To increase the mechanical performances of the seam area 5, the number of the stitching points 6 forming the seam area 5 and/or the diameter of the sewing threads is increased, which has a certain influence. However, this has the effect of weakening the rope that is passed through by multiple stitching points 6. Formation of a longer attachment area increases the space occupation.

A similar problem is present at the level of an attachment ring 3 that is formed by the primary strand 2a and the secondary strand 2b of the rope. These two strands are fixed to one another by a seam area 5 to delineate a ring. When the two strands exiting from the ring are directed in opposite directions, the stitching points 6 closing the ring are also subjected to peeling stress resulting in the same impairment of the mechanical performances. The same is the case when the stress is applied to the inside of the attachment ring 3 thereby seeking to enlarge the circumference of the attachment ring 3.

The primary strand 2a illustrates a connector 7 defining an attachment opening 9 designed to receive a carabiner and formed by the fold of the terminal strand onto the main strand 2′. In this particular case, the two strands are stressed in substantially homogeneous manner so that the stitches work differently from the previous cases. If on the other hand the diameter of the attachment opening is smaller than the diameter of the carabiner it has to receive, the carabiner applies a peeling stress.

It is known to cover the attachment area 4 by a cover 10 made from polymer material as illustrated in FIG. 1. The cover 10 is not able to significantly increase the breaking strength of the attachment area 4 and in particular the resistance. The cover 10 provides protection of the stitching points 6 against external aggression.

Finally, it is known to secure the two strands together by means of a metallic crimping. This operation is complex and costly.

### SUMMARY OF THE INVENTION

One object of the invention consists in palliating these drawbacks, and more particularly in providing an attachment device having an attachment area between two strands that procures better trade-offs between space occupation and breaking strength when the two strands attempt to move away from one another.

These drawbacks tend to be overcome by means of an attachment device comprising:
a first strand of a first rope and a second strand of a second rope;
an attachment area comprising at least two sewing threads joined to one another without forming a knot to form a plurality of stitching points, wherein the first strand has a first longitudinal direction parallel to a second longitudinal direction of the second strand and wherein the first strand is offset from the second strand in a direction perpendicular to the first longitudinal direction;
   wherein the attachment area comprises a seam area formed by a plurality of stitching points performing securing of the first strand pressing on the second strand, each stitch area being formed by two first stitching points, the first stitching points being two consecutive stitching points of the plurality of stitching points, wherein one of the sewing threads of one of the first stitching points passes through the first strand and one of the sewing threads of the other of the first stitching points passes through the second strand.

The attachment device is remarkable in that the attachment area comprises at least one ligature area arranged adjacent to the seam area in the first longitudinal direction and formed by a plurality of ligatures performing attachment of the first strand pressing on the second strand, each ligature being formed by two or three second stitching points, the second stitching points being two or three consecutive stitching points of the plurality of stitching points, wherein one of the sewing threads of one of the second stitching points passes round one of the first strand and the second strand and is pressing on an external lateral edge of said one of the first strand and the second strand that is passed round;
and one of the sewing threads of another of the second stitching points passes round the other of the first strand and the second strand pressing on an external lateral edge of said the other of the first strand and the second strand that is passed round or passed through by the other of the first strand and the second strand.

According to one feature of the invention, the second stitching points comprise stitching points passing round the first strand and stitching points passing round the second strand.

In preferential manner, the stitching points passing round the first strand and the stitching points passing round the second strand are arranged alternately in longitudinal directions of the sewing threads.

In a particular embodiment, the stitching points passing through the other of the first strand and the second strand are stitching points passing through a space situated between the first strand and the second strand.

Advantageously, the seam area and the at least one ligature area are formed by same threads extending continuously from the seam area to the ligature area.

In a particular embodiment, the at least one ligature area comprises two ligature areas adjacent to the seam area, the two ligature areas being separated by the seam area in the first longitudinal direction.

Preferentially, the first strand and second strand each have a core and a sheath and wherein, in the at least one ligature area, the second stitching points pass through the sheath of the other of the first strand and the second strand without passing through the core.

In another development, the attachment device comprises an adjustment device configured to slide along the first strand up to the attachment area forming an end-of-travel stop, the at least one ligature area being arranged between the seam area and a slider of the adjustment device and the second stitching points passing round the second strand.

Advantageously, the first strand and second strand form a loop that is closed by the attachment area and wherein the ligature area is located closer to the loop than the seam area in the longitudinal directions to oppose opening of the loop.

Preferentially, the first strand and the second strand each have a connector. The at least one ligature area is located closer to the connectors than the seam area in the first longitudinal direction and in the second longitudinal direction to prevent the two connectors from moving away from one another.

It is a further object of the invention to provide a lanyard that presents a better trade-off between mechanical performances and size. This result tends to be achieved by means of a lanyard that has an attachment device according to any one of the foregoing configurations.

Preferentially, the attachment device has a first end having an attachment ring designed to be attached to a user and at least a second end having an anchor point designed to be attached to an anchorage

In a preferential embodiment, the first strand and the second strand each have a connection part. The ligature area is arranged closer to the connection parts than the seam area in the longitudinal directions of the first strand and the second strand to prevent the two connection parts from moving away from one another.

Preferentially, the attachment device has a first end having an attachment point designed to be attached to a user and at least a second end having an anchor point designed to be attached to an anchorage.

Advantageously, the attachment device comprises an adjustment device configured to slide along the first strand up to the attachment area forming an end-of-travel stop, the at least one ligature area being arranged between the seam area and a slider of the adjustment device and the second stitching points passing round the second strand so that the lanyard forms an adjustable lanyard. The adjustment device forms the anchor point, the slider being movable between a blocking position and a sliding position, the slider being arranged in fixed manner with respect to the first strand in the blocking position and being free to move along the first strand in the sliding position.

Preferentially, the first strand and the second strand each have a connector. The ligature area is located closer to the connectors than the seam area (5) in the first longitudinal direction and in the second longitudinal direction to prevent the two connectors from moving away from one another. The attachment ring is separated from the anchor points by the attachment area.

### DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a lanyard according to the prior art, the attachment area of which is covered by a cover;

FIG. 2 schematically illustrates the lanyard according to the prior art, the attachment area of which does not comprise a cover;

FIG. 3 schematically illustrates an adjustment device pressing on a terminal strand according to the prior art;

FIG. 4 schematically illustrates a lanyard according to a first embodiment, the attachment area of which does not comprise a cover;

FIG. 5 schematically a rope strand receiving an adjustment device pressing on a terminal strand;

FIG. 6 schematically illustrates an attachment device according to a second embodiment provided with an attachment area of a loop, the two strands thereof being separated from one another outside the loop;

FIG. 7 schematically illustrates an attachment device according to a third embodiment provided with an attachment area of a loop, the two strands thereof being separated from one another inside the loop;

FIG. 8 schematically illustrates an attachment device according to a fourth embodiment provided with an attachment area of a loop, the two strands thereof being separated from one another inside and outside the loop;

FIG. 9 schematically illustrates an attachment area provided with a first embodiment of the ligature area;

FIG. 10 schematically illustrates an attachment area provided with a second embodiment of the ligature area;

FIG. 11 schematically illustrates an attachment area provided with a third embodiment of the ligature area;

FIG. 12 schematically illustrates an attachment area provided with a fourth embodiment of the ligature area;

FIG. 13 schematically illustrates an attachment area provided with a fifth embodiment of the ligature area;

FIG. 14 schematically illustrates an attachment area provided with a sixth embodiment of the ligature area;

FIG. 15 schematically illustrates an attachment area provided with a seventh embodiment of the ligature area.

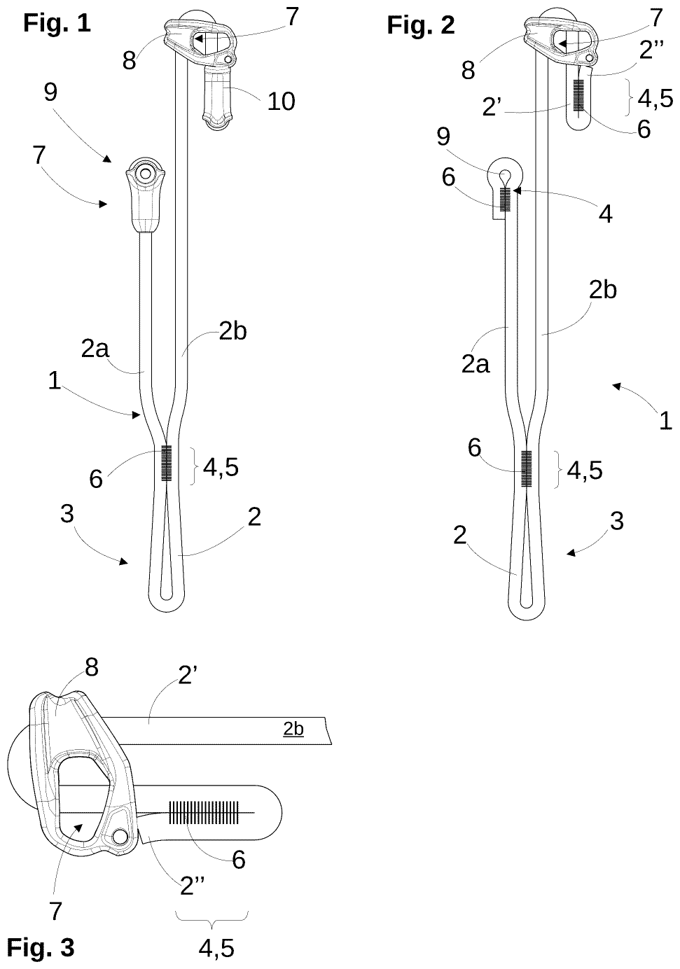

### DETAILED DESCRIPTION

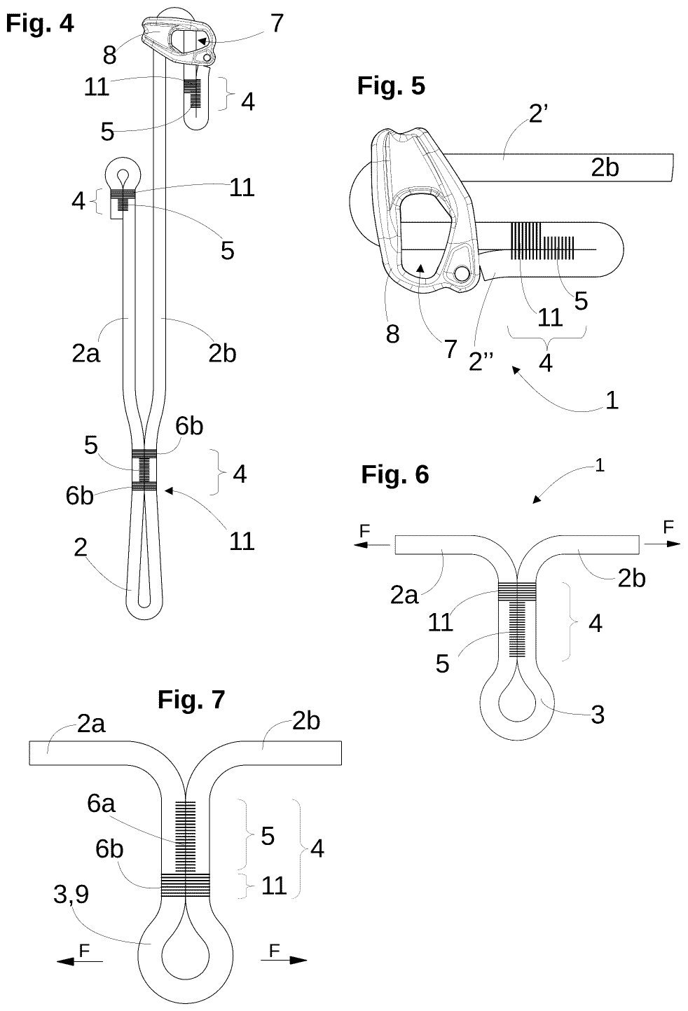

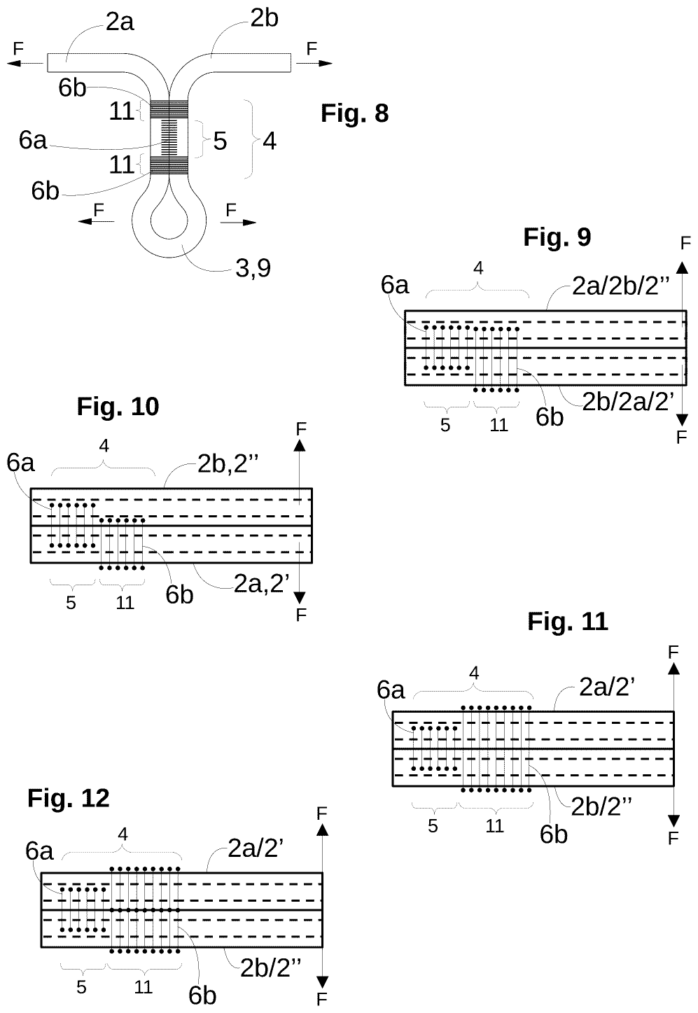

FIG. 4 represents an attachment device that has at least a first strand and a second strand. The attachment device can be a lanyard 1 as illustrated in FIG. 4.

The first strand and the second strand have a length that is larger than the width and larger than the thickness. The length is preferably at least five times larger or at least ten times larger than the width and the thickness. In a particular embodiment, the first strand and/or the second strand have a circular or substantially circular cross-section.

The attachment device has an attachment area 4 where the first strand has a longitudinal direction parallel to a longitudinal direction of the second strand. In the attachment area 4, the first strand is installed in fixed manner pressing on the second strand. The attachment area 4 is formed by a plurality of stitching points 6. What is meant by stitching points is stitching points formed by a sewing machine, i.e. with two threads that join together to pin down a part of the first strand and of the second strand. Two consecutive stitching points are joined to one another by the two threads.

In the attachment area 4, the first strand can be in direct contact with the second strand or the first strand is separated from the second strand by an intercalary part. The stitching points 6 apply a compressive force on the first strand in the direction of the second strand and on the second strand in the direction of the first strand. The first strand and the second strand each present an inner face that are in contact or immediately facing one another in a perpendicular direction to the longitudinal direction of the strands and an outer face that is opposite the inner face in said perpendicular direction.

In the attachment area 4, the first strand and the second strand deform in identical manner in the longitudinal direction of the strands until breaking of the stitching points 6 or of one of the strands takes place.

The attachment area 4 comprises a seam area 5 formed by first stitching points 6a of the plurality of stitching points 6. The first stitching points 6a pass successively through the first strand and the second strand to be arranged fixedly pressing on the second strand. In other words, the sewing machine needle passes through the first strand or through the second strand to make the thread pass, the latter then being wedged in the strand. Passing the thread through the strand enables the position of the thread in the longitudinal direction of the strand to be fixed. A seam area is formed by two successive stitching points that pass respectively through the first strand and the second strand. The seam area passes through the first strand and the second strand, and the tension applied on the two threads secures the first strand with the second strand. The stitching point that passes through the strand weakens the strand. It has been observed that this weakening of the strand results in the latter breaking more easily. This impairment is notable when the attachment area 4 is subjected to peeling stress, i.e. a force that tends to separate the two strands perpendicularly to the longitudinal direction.

To improve the peeling resistance when the first strand and second strand are subjected to forces tending to separate the first strand and second strand, the attachment area 4 comprises a ligature area 11 where the first strand has a longitudinal direction parallel to a longitudinal direction of the second strand and where the first strand is installed fixedly pressing on the second strand.

The ligature area 11 is formed by several ligatures formed one behind the other in the longitudinal direction of the strands. The ligature areas are preferentially pressing against one another in the longitudinal direction of the strands. The ligature is formed by two consecutive stitching points, one of the stitching points passing round the first strand and the other stitching point passing through the second strand or round the second strand. The opposite is also possible. As an alternative, the ligature is formed by three consecutive stitching points, one stitching point passing round the first strand, one stitching point passing between the first strand and second strand, and the last stitching point passing round the second strand.

In a scam, a sewing thread passes through the first strand and the second strand, preferably passing through the strand along a diameter of the strand, i.e. to have the maximum interaction with the strand. In a ligature, the bond between the two strands has a weak interaction with at least one of the strands to avoid impairing the mechanical performances in the longitudinal direction of the strands and preferably to avoid impairing the mechanical performances of the two strands in the longitudinal direction of the strands. It is therefore advantageous not to pass through the strand or strands or to limit passing through the strand or strands.

What is meant by passing round a strand is that the sewing threads circumvent the outer face of the strand without penetrating into the strand. It is also possible for the sewing thread to penetrate into the periphery of the strand, for example over a distance that corresponds to less than 33% of the diameter of the strand. The thread penetrates into the outer part of the strand and not into the inner part.

The ligatures are formed by the second stitching points 6b of the plurality of stitching points 6. The second stitching points 6b are formed in identical manner to the first stitching points, but in the couples of two consecutive second stitching points 6b, at least the one of the second stitching points 6b passes round at least one of the first strand and the second strand. The tension force applied in the sewing threads presses the two strands against one another in a direction perpendicular to the longitudinal direction. The smaller the distance of penetration of the sewing thread into the strand, the more the sewing thread is able to move in the longitudinal direction of the thread to homogenise the tension in the thread. As the tension in the sewing thread is more homogeneous between the multiple second stitching points 6b, the mechanical behaviour of the second stitching points 6b is different from the mechanical behaviour of the first stitching points 6a with regard to a predefined stress that tends to separate the first strand and the second strand.

The portion of sewing thread that passes round the strand prevents the strand from being weakened. When a peeling stress is applied, the ligature enables the force that tends to press the two strands against one another to be maintained without having a stitching point that passes through the central part of the strand and applies a stress in the longitudinal direction of the strand. Movement of the ligature in the longitudinal direction of the strands is prevented by having a second stitching point 6b that passes through the other strand or that is pressing against the seam area 5. It is particularly advantageous for the ligatures to be arranged one against the other in the longitudinal direction of the strands and possibly for an end ligature to be pressing against a stitching of the seam area 5.

The attachment area 4 comprises at least one ligature area 11 that is arranged adjacent to the seam area 5 in the longitudinal directions of the strands. In the ligature area 11, the stitching points 6 are mainly or exclusively the second stitching points 6b. In the seam area 5, the stitching points 6 are mainly or exclusively the first stitching points 6a. Advantageously, the ligature area 11 is devoid of the first stitching points 6a.

It is particularly advantageous for the second stitching points 6b to number at least five consecutive second stitching points 6b in the longitudinal direction of the sewing threads in order to have strong bonds between the first strand and the second strand.

The second stitching points 6b are arranged one behind the other in the longitudinal direction of the sewing threads.

The threads forming the first stitching points 6a and the second stitching points 6b are threads that are subjected to a tensile stress to make the first strand press against the second strand in a direction perpendicular to the longitudinal direction of the strands. The threads compress the strands.

The stitchings of the seam area 5 are arranged one behind the other in the longitudinal direction of the strands. Preferentially, the first stitching points 6a are made alternately in the first strand and in the second strand.

The ligatures of the ligature area 11 are arranged one behind the other in the longitudinal direction of the strands. Preferably, the ligature area 11 has at least five ligatures. Preferentially, the second stitching points 6b are made alternately in the first strand and circumventing the second strand. Circumvention is achieved by passing round the outer face of the strand, i.e. the face opposite the inner face. The inner face of the first strand is immediately facing the inner face of the second strand. It is further possible to provide several groups of three second stitching points 6b that comprise circumvention of the first strand, a second stitching point 6b formed between the inner faces of the strands and circumvention of the second strand.

It is particularly advantageous for the first strand and/or the second strand to have a core and a sheath having different mechanical properties. The sheath is preferentially a material braided or knitted around the core. The core is preferentially formed by threads that extend in parallel or substantially parallel manner to one another. It is particularly advantageous for the first strand and the second strand to have the same configuration with a core and a sheath. More advantageously, the sheaths of the first strand and the second strand are identical and the cores of the first strand and the second strand are identical. Advantageously, the first strand and the second strand belong to one and the same rope 2.

In an advantageous configuration, the first strand is extended by the second strand. More advantageously, the core of the first strand is extended by the core of the second strand and/or the sheath of the first strand is extended by the sheath of the second strand.

In an alternative embodiment, the first strand and the second strand belong to two different ropes. It is also possible for the two ropes to have different characteristics. For example, the two strands differ from one another by different diameters, different materials forming the sheath, different materials forming the core, different braiding or knitting patterns forming the sheaths or a different number of threads forming the core.

When the first strand and the second strand have a structure with a core and a sheath, the second stitching points 6b that pass round the first strand or the second strand are second stitching points 6b that do not pass through the core of the first strand or of the second strand. Preferentially, the sewing thread passes through the outer half of the thickness of the sheath, and even more preferentially it does not pass through the sheath.

It is advantageous for the second stitching points 6b to pass round at least one of the core of the first strand and the core of the second strand and preferentially one of the sheath of the first strand and the sheath of the second strand. Circumventing the sheath, i.e. not passing through the thickness of the first strand and/or the second strand, means that the strand is not weakened.

Different configurations of the second stitching points 6b are made to form the ligatures that are best suited to requirements. In the embodiment illustrated in FIG. 4, three distinct and different attachment areas 4 are formed to accommodate different stresses.

FIG. 4 illustrates a lanyard 1 having a first end designed to be attached to a roping harness and two second ends designed to be attached to an anchor point. The lanyard 1 is formed by a single rope 2 that is folded several times to define the different anticipated functions, here a ring that forms a loop, another ring that forms a connector 7 and an end-of-travel stop.

The rope 2 has a primary strand 2a and a secondary strand 2b that are secured to one another by an attachment area 4. The primary strand 2a forms the first strand whereas the secondary strand 2b forms the second strand. In the illustrated embodiment, the primary strand 2a extends the secondary strand 2b so that the attachment area 4 delineates an attachment ring 3 or a ring designed to receive a connector 7.

As the attachment ring 3 may be subjected to a stress tending to separate the first strand and second strand inside the attachment ring 3, it is advantageous for the attachment area 4 to comprise a ligature area 11 arranged between the attachment ring 3 and the seam area 5. In other words, the ligature area 11 is located inside the attachment ring 3 closed by the seam area 5.

On exit from the attachment area 4, inside the attachment ring 3, a free area exists where it is possible to move the first strand and second strand independently from one another to apply the force tending to separate the two strands. It is advantageous to form the second stitching points 6b that pass round the first strand and second strand. In the free area, the two strands are not joined to one another.

In a particular embodiment, the second stitching points 6b have at least one second stitching point 6b where the two threads that form the second stitching points overlap the first strand and the second strand in one go. In other words, the two threads that form the consecutive second stitching points 6b join one another at two attachment points that are separated by the first strand and the second strand.

In another particular embodiment, the second stitching points 6b have at least one second stitching point 6b where the two threads that form the second stitching points 6b overlap the first strand in only one go and overlap the second strand in only one go. The second stitching points 6b have links between the two sewing threads that are situated between the first strand and the second strand. In preferential manner, the second stitching points 6b present an alternation between a ligature overlapping the first strand and a ligature overlapping the second strand. Alternation of the second stitching points 6b between the first strand and second strand enables the stitches to work better. When the second stitching points 6b are sewn, the needle is depressed between the two strands without penetrating into the strands, which avoids impairing the mechanical performances of the strands in the longitudinal direction. It is possible for the needle to penetrate into the circumference of the strand, for example less than 10% of the diameter from the edge, thereby enabling mechanical impairment to be limited. The sewing threads are pinned between the first strand and second strand, thereby enabling the position of the second stitching points to be preserved when a stress tending to separate the first strand and second strand is applied.

In another particular embodiment, the second stitching points have at least one stitching point where the two threads that form the second stitching points overlap the first strand in one go and overlap the second strand in one go. The second stitching points have links between the two sewing threads that are situated between the first strand and the second strand. In other words, the two threads forming the second stitching points join one another at two attachment points that are separated by the first strand and the second strand. There again, it is advantageous to alternate a stitching point around the first strand and a stitching point around the second strand. The use of two threads that join together to delineate each ligature enables the stresses along the ligatures to be better managed, resulting in a better distribution of work over the whole length of the ligature area.

In another particular embodiment, the second stitching points 6b have at least one second stitching point 6b where the two threads forming the second stitching points 6b pass through one of the first strand and the second strand and pass round the other of the first strand and the second strand. It is preferable for the thread or threads that pass through one of the first strand and the second strand to pass substantially through the centre of the strand. The threads that exit from the strand overlap the other of the first strand and the second strand and join one another outside the other strand to attach the first strand securely with the second strand. There again, it is advantageous to alternate a ligature around the first strand and a ligature around the second strand. In other words, an alternation exists between a ligature that passes through the first strand and is secured against the second strand and a ligature that passes through the second strand and is secured against the first strand.

In the embodiment illustrated in FIG. 4, a configuration also exists where a part is able to slide along a main strand 2′ and where a terminal strand 2″ is fixed to the main strand 2′ to form an end-of-travel stop. The end-of-travel stop is formed by a first strand and a second strand attached to one another by an attachment area 4. The ligature area 11 is located between an adjustment device 8 formed by a sliding part and the seam area 5. The ligature area 11 enables the stresses applied by the sliding part pressing against the attachment area 4 to be better withstood in comparison with an attachment area 4 only comprising a single seam area 5.

The sliding part generates a force on the terminal strand 2″ that tends to separate the main strand 2′ and the terminal strand 2″. To improve the peeling resistance performances of the attachment area 4, the attachment area 4 has a ligature area 11. The ligature area 11 is arranged between the seam area 5 and the sliding part in the longitudinal direction of the main strand 2′.

The ligature area 11 can have the second stitching points 6b that pass round main strand 2′.

FIGS. 9 to 15 illustrate different embodiments of an attachment area 4 with multiple variants of the configuration of the ligature area 11.

FIG. 9 and FIG. 10 illustrate a ligature area 11 where the second stitching points 6b are sunk in the first strand and pass round the second strand. The first strand can be a primary strand 2a or a secondary strand 2b. The first strand is preferentially a terminal strand 2″. The second strand is formed by the other strand. In FIG. 9, the sewing thread passes through the core whereas in FIG. 10 the sewing thread only passes through the sheath.

FIG. 11 and FIG. 12 illustrate a ligature area 11 where the second stitching points 6b do not penetrate into the first strand or into the second strand. The sewing threads pass round the outer faces of the first strand and of the second strand. The first strand can be a primary strand 2a or a secondary strand 2b. The first strand is preferentially a terminal strand 2″. The second strand is formed by the other strand. FIG. 11 illustrates straddling of the two strands whereas FIG. 12 illustrates a stitching made between the two strands.

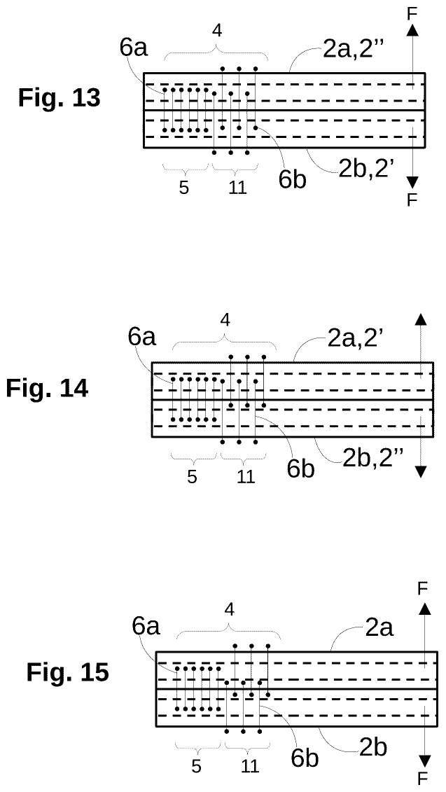

FIGS. 13, 14, 15 illustrate a ligature area 11 where the second stitching points 6b are sunk alternately into the first strand and then into the second strand. The sewing threads pass alternately round the outer faces of the second strand and of the first strand. Depending on the configurations, the sewing threads are sunk so as to pass through the two cores (FIG. 13), the two sheaths without the cores (FIG. 15) or a single core (FIG. 14). The first strand can be a primary strand 2a or a secondary strand 2b. The first strand is preferentially a terminal strand 2″. The second strand is formed by the other strand.

It is also advantageous to have a roping harness having a lanyard 1 such as the one illustrated in one of the foregoing embodiments.

1. Attachment device comprising:
a first strand of a first rope and a second strand of a second rope;
an attachment area comprising at least two sewing threads joined to one another without forming a knot to form a plurality of stitching point, wherein the first strand has a first longitudinal direction parallel to a second longitudinal direction of the second strand and wherein the first strand is offset from the second strand in a direction perpendicular to the first longitudinal direction;
wherein the attachment area comprises a seam area formed by a plurality of stitches performing securing of the first strand pressing on the second strand, each stitch being formed by two first stitching points, the first stitching points being two consecutive stitching points of the plurality of stitching points, wherein one of the sewing threads of one of the first stitching points passes through the first strand and one of the sewing threads of the other of the first stitching points passes through the second strand;
wherein the attachment area comprises at least one ligature area arranged adjacent to the seam area in the first longitudinal direction and formed by a plurality of ligatures performing attachment of the first strand pressing on the second strand, each ligature being formed by two or three second stitching points, the second stitching points being two or three consecutive stitching points of the plurality of stitching points, wherein one of the sewing threads of one of the second stitching points passes round one of the first strand and the second strand and is pressing on an external lateral edge of said one of the first strand and the second strand that is passed round;
and one of the sewing threads of another of the second stitching points (6b) passes round the other of the first strand and the second strand pressing on an external lateral edge of said the other of the first strand and the second strand that is passed round or passed through by the other of the first strand and the second strand.

2. Attachment device according to claim 1 wherein the second stitching points comprise stitching points passing round the first strand and stitching points passing round the second strand.

3. Attachment device according to claim 2 wherein the stitching points passing round the first strand and the stitching points passing round the second strand are arranged alternately in longitudinal directions of the sewing threads.

4. Attachment device according to claim 2 wherein the stitching points passing through the other of the first strand and the second strand are stitching points passing through a space situated between the first strand and the second strand.

5. Attachment device according to claim 1 wherein the seam area and the at least one ligature area are formed by same threads extending continuously from the seam area to the at least one ligature area.

6. Attachment device according to claim 1 where the at least one ligature area comprises two ligature areas adjacent to the seam area, the two ligature areas being separated by the seam area in the first longitudinal direction.

7. Attachment device according to claim 1 wherein the first strand and second strand each have a core and a sheath and wherein, in the at least one ligature area, the second stitching points pass through the sheath of the other of the first strand and the second strand without passing through the core.

8. Attachment device according to claim 1 comprising an adjustment device configured to slide along the first strand up to the attachment area forming an end-of-travel stop, the at least one ligature area being arranged between the seam area and a slider of the adjustment device and the second stitching points passing round the second strand.

9. Attachment device according to claim 1 wherein the first strand and second strand form a loop that is closed by the attachment area and wherein the at least one ligature area is located closer to the loop than the seam area in the longitudinal directions to oppose opening of the loop.

10. Attachment device according to claim 1 wherein the first strand and the second strand each have a connector and wherein the at least one ligature area is located closer to the connectors than the seam area in the first longitudinal direction and in the second longitudinal direction to prevent the two connectors from moving away from one another.

11. Lanyard comprising an attachment device according to claim 1, the attachment device having a first end having an attachment ring designed to be attached to a user and at least a second end having an anchor point designed to be attached to an anchorage.

12. Lanyard according to claim 11 wherein the attachment device comprises an adjustment device configured to slide along the first strand up to the attachment area forming an end-of-travel stop, the at least one ligature area being arranged between the seam area and a slider of the adjustment device and the second stitching points passing round the second strand so that the lanyard forms an adjustable lanyard and wherein the adjustment device forms the anchor point, the slider being movable between a blocking position and a sliding position, the slider being arranged in fixed manner with respect to the first strand in the blocking position and being free to move along the first strand in the sliding position.

13. Lanyard according to claim 11 comprising an attachment device wherein the first strand and the second strand each have a connector, wherein the at least one ligature area is located closer to the connectors than the seam area in the first longitudinal direction and in the second longitudinal direction to prevent the two connectors from moving away from one another and wherein the attachment ring is separated from the anchor points by the attachment area.

14. Method for manufacturing an attachment device according to claim 1 comprising the following steps:
providing a first strand and a second strand;
securing the first strand in contact with the second strand, the first strand having a longitudinal direction parallel to a longitudinal direction of the second strand;
wherein the securing step comprises a stitching step using at least two sewing threads defining first stitching points passing successively through the first strand and the second strand to secure the first strand with the second strand;
characterised in that prior to or subsequent to the stitching step, the method comprises a ligature step that fixes the first strand pressing firmly against the second strand, the ligature being formed by at least two threads joined to one another to define second stitching points, each ligature passing round at least one of the first strand and the second strand and being joined to the other of the first strand and the second strand, being pressing on an external lateral edge of said one of the first strand and the second strand that was passed round, the ligature area being arranged adjacent to the seam area in the longitudinal directions of the first strand and second strand.

15. Method for manufacturing a rope according to claim 14 wherein the ligature step and the stitching step are performed by means of the same sewing machine, the sewing threads extending continuously between the ligature step and the stitching step.
